(19) United States
(12) Patent Application Publication
(10) Pub. No.: US 2022/0058258 A1
(43) Pub. Date: Feb. 24, 2022

(54) SYSTEM AND CONTROL DEVICE

(71) Applicant: KABUSHIKI KAISHA TOKAI RIKA DENKI SEISAKUSHO, Aichi (JP)

(72) Inventors: Takanori MATSUYAMA, Aichi (JP); Yosuke HASEGAWA, Aichi (JP); Yosuke OHASHI, Aichi (JP)

(73) Assignee: KABUSHIKI KAISHA TOKAI RIKA DENKI SEISAKUSHO, Aichi (JP)

(21) Appl. No.: 17/354,303

(22) Filed: Jun. 22, 2021

(30) Foreign Application Priority Data
Aug. 21, 2020 (JP) 2020-140058

(51) Int. Cl. G06F 21/44; G06F 7/76; G06F 7/575

(52) U.S. Cl. CPC G06F 21/44; G06F 7/575; G06F 7/768

(57) ABSTRACT

To achieve authentication of devices with higher security.

A system includes: a first device, and a plurality of second devices. The first device transmits a generated confirmation request including first information to the second devices. Each of the second devices performs an arithmetic operation based on the received confirmation request, second information set in common for the second devices, and an arithmetic method specific to each of the second devices, and transmits a confirmation response including a result of the arithmetic operation to the first device. The first device authenticates each of the second devices on the basis of the confirmation response transmitted by each of the second devices.

### CROSS REFERENCE TO RELATED APPLICATION(S)

This application is based upon and claims benefit of priority from Japanese Patent Application No. 2020-140058, filed on Aug. 21, 2020, the entire contents of which are incorporated herein by reference.

### BACKGROUND

The present invention relates to a system and a control device.

Recently, there have been developed a number of systems operated by the cooperation of a plurality of devices. For example, Japanese Patent Application Laid-open No. 2019-193112 discloses a system including a master and a plurality of slaves.

### SUMMARY

In the above-described system, the devices may be authenticated for cooperative operation. Then, the mechanism for achieving authentication with higher security has been demanded.

In view of the above-described aspects, the present invention aims at providing a mechanism capable of achieving authentication of devices with higher security.

To solve the above-described problem, one aspect of the present invention provides a system including a first device, and a plurality of second devices, in which the first device transmits a generated confirmation request including first information to the second devices, each of the second devices performs an arithmetic operation based on the received confirmation request, second information set in common for the second devices, and an arithmetic method specific to each of the second devices, and transmits a confirmation response including a result of the arithmetic operation to the first device, and the first device authenticates each of the second devices on the basis of the confirmation response transmitted by each of the second devices.

Moreover, to solve the above-described problem, another aspect of the present invention provides a control device including a control unit configured to transmit a generated confirmation request including first information to other devices, and authenticate the other devices on the basis of a confirmation response transmitted by the other devices in response to the confirmation request, in which the control unit transmits the confirmation request to the other devices, and receives, from each of the second devices, a confirmation response including a result of an arithmetic operation based on the confirmation request, second information set in common for the other devices, and an arithmetic method specific to each of the second devices.

As described above, the present invention provides a mechanism capable of achieving authentication of devices with higher security.

### BRIEF DESCRIPTION OF THE DRAWINGS

FIG. 1 is a block diagram illustrating a configuration example of a system 1 according to an embodiment of the present invention.

FIG. 2 is a block diagram illustrating a functional configuration example of a control device 10 according to the embodiment.

FIG. 3 is a block diagram illustrating a functional configuration example of a processing device 20 according to the embodiment.

FIG. 4 is a sequence diagram illustrating an example of a flow of operation by the system 1 according to the embodiment.

FIG. 5 is a diagram for explaining an arithmetic method of extracting a bit string different for each of the processing devices 20 from a bit string corresponding to first information according to the embodiment.

FIG. 6 is a diagram for explaining an arithmetic method of processing the first information by a method different for each of the processing devices 20 according to the embodiment.

FIG. 7 is a diagram for explaining an arithmetic method of extracting a bit string different for each of the processing devices 20 from a bit string corresponding to second information according to the embodiment.

FIG. 8 is a diagram for explaining an arithmetic method of processing the second information by a method different for each of the processing devices 20 according to the embodiment.

FIG. 9 is a diagram for explaining an arithmetic method of extracting a bit string different for each of the processing devices 20 from an arithmetic result according to the embodiment.

FIG. 10 is a diagram for explaining an arithmetic method of processing an arithmetic result by a method different for each of the processing devices 20 according to the embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Embodiment

### 1.1. System Configuration Example

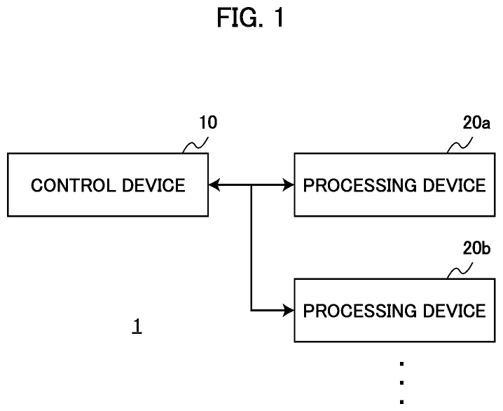

First, there will be described a configuration example of the system 1 according to an embodiment of the present invention. FIG. 1 is a diagram illustrating a configuration example of the system 1 according to an embodiment of the present invention. As illustrated in FIG. 1, the system 1 of the embodiment includes a control device 10 and a plurality of processing devices 20.

The control device 10 is an example of a first device of the present invention. Each of the processing devices 20 is an example of a second device of the present invention.

Control Device 10

The control device 10 of the embodiment controls operation of the processing devices 20.

For example, in the system 1, the control device 10 of the embodiment may operate as a master controlling a plurality of processing devices operating as slaves.

Moreover, the control device 10 of the embodiment authenticates each of the processing devices 20 when controlling the processing devices 20.

For example, the control device 10 may transmit a confirmation request to each of the processing devices 20, and authenticate each of the processing devices 20 on the basis of a confirmation response transmitted by each of the processing devices 20 in response to the confirmation request.

To be more specific, the control device 10 of the embodiment may transmit a generated confirmation request including the first information to a plurality of processing devices 20, and authenticate each of the processing devices 20 on the basis of an arithmetic result included in a confirmation response transmitted by each of the processing devices 20.

Processing Device 20

The processing device 20 of the embodiment performs various kinds of processing on the basis of the control by the control device 10.

Here, the processing device 20 of the embodiment transmits a confirmation response in response to a confirmation request transmitted by the control device 10, and is subjected to authentication by the control device 10 on the basis of the confirmation response.

For example, each of the processing devices 20 of the embodiment may perform an arithmetic operation based on the first information included in the received confirmation request and the second information set in common for a plurality of processing devices 20, and transmit a confirmation response including a result of the arithmetic operation to the control device 10.

The above has described the configuration example of the system 1 of the embodiment. The control device 10 and the processing devices 20 of the embodiment may be configured to achieve a wireless communication function in vehicles, for example. Such a wireless communication function includes, for example, a wireless communication function using ultra-wide band (UWB) frequencies.

In this case, the control device 10 may authenticate the processing device 20 every time, and perform, if the processing device 20 is authenticated, processing based on a result of wireless communication performed by the processing device 20, for example.

Meanwhile, it is supposed here that in the authentication based on a result of an arithmetic operation using the information transmitted by the control device 10 (first information) and the information set for a plurality of processing devices 20 (second information), the first information and the second information are common for a plurality of processing devices 20.

In this case, if a third party illegally obtains the first information or the second information, a result of an arithmetic operation using the first information and the second information may be camouflaged, thereby establishing unintended authentication.

The technical ideas of the present invention have been made in view of the above-described aspects, and enables authentication of the devices with higher security.

Note that the first information included in a confirmation request of the embodiment includes, for example, a random bit string (random number), and the like. Moreover, the second information set in common for a plurality of processing devices 20 of the embodiment includes, for example, a cryptographic key, a password, a constant, and the like.

For example, each of the processing devices 20 of the embodiment may perform a hash operation using a received random number (first information) and a common cryptographic key (second information), and transmit a confirmation response including a result of the hash operation to the control device 10.

Here, each of the processing devices 20 of the embodiment is characterized in performing an arithmetic operation using an arithmetic method specific to each of the processing devices 20.

For example, each of the processing devices 20 of the embodiment may apply an arithmetic method specific thereto to the first information, and perform an arithmetic operation using the first information to which the specific arithmetic method is applied, so as to transmit a confirmation response including a mutually different arithmetic result to the control device 10.

Moreover, for example, each of the processing devices 20 of the embodiment may apply an arithmetic method specific thereto to the second information, and perform an arithmetic operation using the second information to which the specific arithmetic method is applied, so as to transmit a confirmation response including a mutually different arithmetic result to the control device 10.

Moreover, for example, each of the processing devices 20 of the embodiment may apply an arithmetic method specific thereto to a result of an arithmetic operation using the first information and the second information, and transmit a confirmation response including a mutually different arithmetic result to the control device 10.

With the above-described control, it is possible to generate an individually different arithmetic result even in a case where the first information and the second information are common for the processing devices 20. Moreover, the control device 10 of the embodiment can authenticate each of the processing devices 20 on the basis of the confirmation response including an above-described individually different arithmetic result.

In this manner, the system 1 of the embodiment can effectively prevent a camouflage of a correct arithmetic result even in a case where a third party illegally obtains the first information and the second information, and thus achieve a system with higher security. Moreover, the system 1 of the embodiment does not require setting of the first information and the second information for each of the processing devices 20, and can thus simplify information management and operation.

The following will more specifically describe the configuration of each device achieving the above.

### 1.2. Functional Configuration Example of Control Device 10

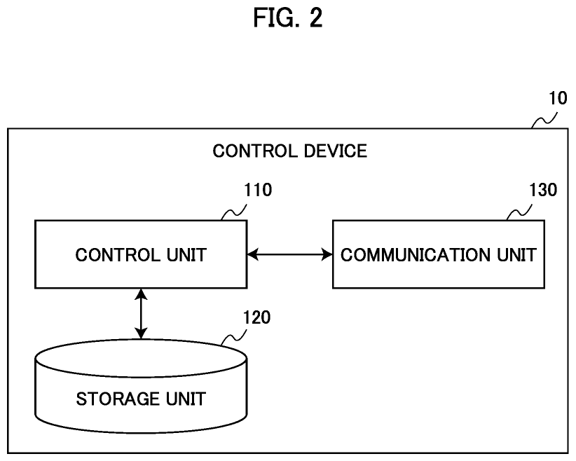

First, there will be described a functional configuration example of the control device 10 of the embodiment. FIG. 2 is a block diagram illustrating a functional configuration example of the control device 10 according to the embodiment.

As illustrated in FIG. 2, the control device 10 of the embodiment may include a control unit 110, a storage unit 120, and a communication unit 130.

Control Unit 110

The control unit 110 of the embodiment controls a plurality of processing devices 20.

In the above-described control, the control unit 110 of the embodiment transmits a generated confirmation request including the first information to the processing device 20, and authenticates the processing device 20 on the basis of a confirmation response transmitted by the processing device 20 in response to the confirmation request.

Here, the control unit 110 of the embodiment may transmit a confirmation request to a plurality of processing devices 20 through the communication unit 130, and receive a confirmation response from each of the processing devices 20 through the communication unit 130. The confirmation response may include a result of an arithmetic operation based on the confirmation request, the second information set in common for the processing devices 20, and an arithmetic method specific to each of the processing devices 20.

The functions of the control unit 110 of the embodiment are achieved by various kinds of processors.

Storage Unit 120

The storage unit 120 of the embodiment stores various kinds of information used by the control device 10. For example, the storage unit 120 stores various kinds of programs used by the control unit 110.

Moreover, for example, the storage unit 120 stores information used for authentication of the processing deices 20 by the control unit 110. The examples of such information include, for example, the above-described first information, second information, arithmetic method specific to each of the processing device 20, and the like.

Communication Unit 130

The communication unit 130 of the embodiment performs information communication with the processing device 20 on the basis of the control by the control unit 110. For example, the communication unit 130 transmits a confirmation request to the processing device 20 on the basis of the control by the control unit 110. Moreover, the communication unit 130 receives a confirmation response from the processing device 20.

The above has described the functional configuration example of the control device 10 of the embodiment. Note that the functional configuration described above using FIG. 2 is an example, and the functional configuration of the control device 10 of the embodiment is not limited thereto. The functional configuration of the control device 10 of the embodiment can be modified flexibly depending on specifications and uses.

### 1.3. Functional Configuration Example of Processing Device 20

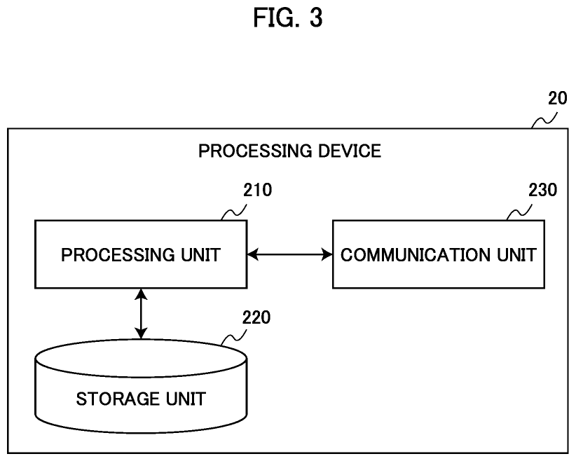

The following will describe a functional configuration example of the processing device 20 according to the embodiment. FIG. 3 is a block diagram illustrating a functional configuration example of the processing device 20 according to the embodiment.

As illustrated in FIG. 3, the processing device 20 of the embodiment may include a processing unit 210, a storage unit 220, and a communication unit 230.

Processing Unit 210

The processing unit 210 of the embodiment performs various kinds of processing in accordance with the control of the control device 10.

For example, the processing unit 210 of the embodiment performs an arithmetic operation based on a confirmation request received through the communication unit 230, the second information set in common for the processing devices 20, and an arithmetic method specific to each of the processing devices 20, and transmits a confirmation response including a result of the arithmetic operation to the control device 10.

The functions of the processing unit 210 of the embodiment are achieved by various kinds of processors. Note that the details of the functions of the processing unit 210 of the embodiment will be described separately.

Storage Unit 220

The storage unit 220 of the embodiment stores various kinds of information used by the processing device 20. For example, the storage unit 220 stores various kinds of programs used by the processing unit 210.

Moreover, for example, the storage unit 220 stores information used for the arithmetic operation by the processing unit 210. The examples of such information include, for example, the above-described first information, second information, arithmetic method specific to each of the processing device 20, and the like.

Communication Unit 230

The communication unit 230 of the embodiment performs information communication with the control device 10 on the basis of the control by the processing unit 210. For example, the communication unit 230 receives a confirmation request from the control device 10. Moreover, for example, the communication unit 230 transmits a confirmation response to the control device 10 on the basis of the control by the processing unit 210.

The above has described the functional configuration example of the processing device 20 according to the embodiment. Note that the functional configuration described above using FIG. 3 is an example, and the functional configuration of the processing device 20 of the embodiment is not limited thereto. The functional configuration of the processing device 20 of the embodiment can be modified flexibly depending on specifications and uses.

### 1.4. Flow of Processing

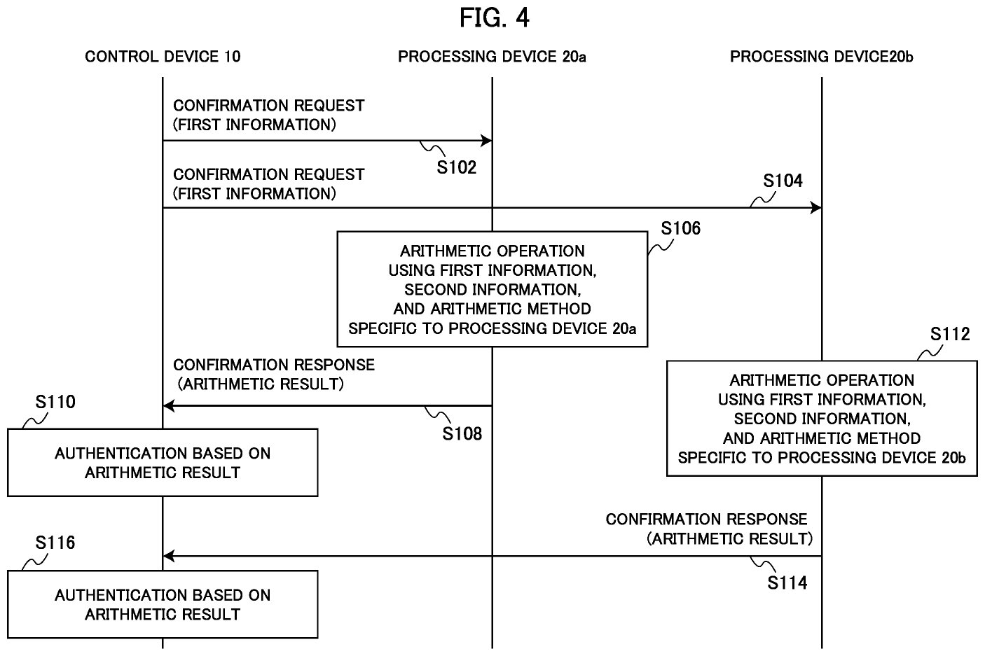

The following will specifically describe a flow of processing by the system 1 according to the embodiment. FIG. 4 is a sequence diagram illustrating an example of a flow of operation by the system 1 according to the embodiment.

Note that in FIG. 4, the system 1 of the embodiment includes the control device 10 and two processing devices 20a and 20b. Each of the processing devices 20a and 20b is connected to the control device 10 to be able to communicate information therewith.

As illustrated in FIG. 4, the communication unit 130 of the control device 10 transmits a confirmation request including the first information to the processing device 20a on the basis of the control by the control unit 110 (S102).

Similarly, the communication unit 130 of the control device 10 also transmits a confirmation request including the first information to the processing device 20b (S104).

Next, a processing unit 210a of the processing device 20a performs an arithmetic operation using the first information included in the confirmation request received through a communication unit 230a at Step S102, the second information stored in a storage unit 220a, and the arithmetic method specific to the processing device 20a (S106).

Moreover, the processing unit 210a of the processing device 20a transmits a confirmation response including a result of the arithmetic operation performed at Step S106 to the control device 10 through the communication unit 230a (S108).

Next, the control unit 110 of the control device 10 authenticates the processing device 20a on the basis of the arithmetic result included in the confirmation response received through the communication unit 130 at Step S108 (S110).

Similarly, a processing unit 210b of the processing device 20b performs an arithmetic operation using the first information included in the confirmation request received through a communication unit 230b at Step S104, the second information stored in a storage unit 220b, and the arithmetic method specific to the processing device 20b (S112).

Moreover, the processing unit 210b of the processing device 20b transmits a confirmation response including a result of the arithmetic operation performed at Step S112 to the control device 10 through the communication unit 230b (S114).

Next, the control unit 110 of the control device 10 authenticates the processing device 20b on the basis of the arithmetic result included in the confirmation response received through the communication unit 130 at Step S114 (S116).

The above has described the flow of the operation by the system 1 of the embodiment using an example. As described above, in the system 1 of the embodiment, each of the processing devices 20 performs an arithmetic operation using an arithmetic method specific thereto, and is subjected to authentication based on a result of the arithmetic operation.

In the above-described processing, even in a case where the first information transmitted from the control device 10 and the predetermined second information are common for the processing devices 20, each of the processing devices 20 can obtain an individually different arithmetic result, and can be subjected to authentication based on such an arithmetic result.

In this manner, even if a third party illegally obtains the first information or the second information, it is possible to prevent a camouflage of a correct arithmetic result and effectively exclude impersonation and the like.

### 1.5. Details of Arithmetic Operation

The following will specifically describe the arithmetic operation by the processing device 20 of the embodiment using a concrete example.

As described above, the processing device 20 of the embodiment performs an arithmetic operation based on the first information included in the received confirmation request, the second information set in common for the processing devices 20, and the arithmetic method specific to each of the processing devices 20.

Here, various methods can be applied as the arithmetic method specific to each of the processing devices 20.

For example, the arithmetic method specific to each of the processing devices may include extracting a bit string different for each of the processing devices 20 from a bit string corresponding to the first information included in the confirmation request.

In this case, each of the processing devices may perform an arithmetic operation using the bit string individually extracted from the bit string corresponding to the first information and the second information set in common for the processing devices 20, and transmit a confirmation response including a result of the arithmetic operation to the control device 10.

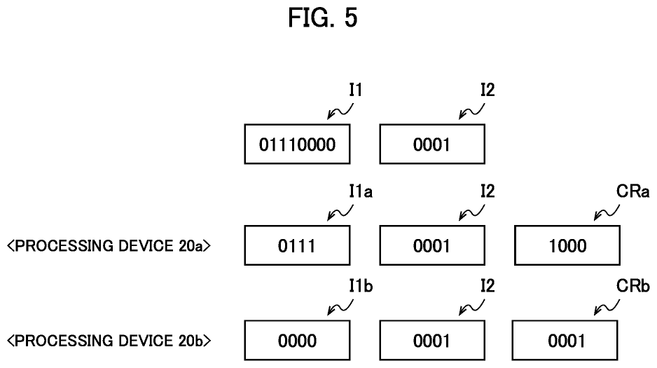

FIG. 5 is a diagram for explaining an arithmetic method of extracting a bit string different for each of the processing devices 20 from a bit string corresponding to the first information according to the embodiment.

FIG. 5 illustrates, in the upper stage thereof, an example of a bit string corresponding to the first information I1 included in a confirmation request and a bit string corresponding to the second information I2 set in common for the processing devices 20.

Here, each of the processing devices 20 may extract an individually different bit string from the bit string corresponding to the first information I1, and use the extracted bit string for an arithmetic operation.

For example, in the case of an example illustrated in FIG. 5, the processing device 20a may extract a bit string of the first four digits from the bit string corresponding to the first information I1, and perform an arithmetic operation using the extracted bit string I1a and the second information I2 to obtain an arithmetic result CRa.

Meanwhile, the processing device 20b may extract a bit string of the last four digits from the bit string corresponding to the first information I1, and perform an arithmetic operation using the extracted bit string I1b and the second information I2 to obtain an arithmetic result CRb.

Note that although the above has described the case where each of the processing devices 20 extracts a bit string not overlapping mutually from the bit string corresponding to the first information I1, a part of the bit strings extracted by the processing devices 20 may be overlapped.

In the above-described processing, each of the processing devices 20 can obtain a mutually different arithmetic result CR using the same first information I1 and the same second information I2.

Moreover, for example, the arithmetic method specific to each of the processing devices 20 of the embodiment may include processing the first information included in a confirmation request by a method different for each of the processing devices 20.

In this case, each of the processing devices 20 may perform an arithmetic operation using the individually processed first information and the second information set in common for the processing devices 20, and transmit a confirmation response including a result of the arithmetic operation to the control device 10.

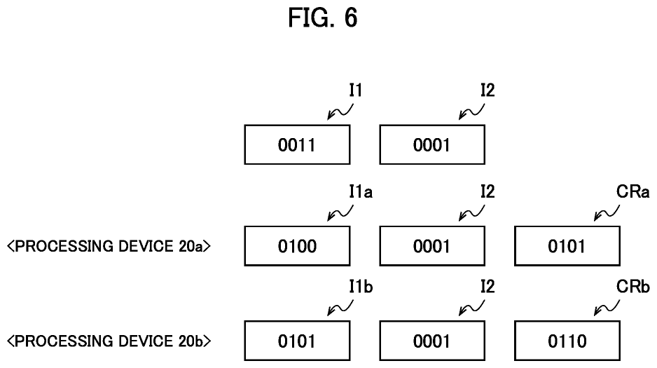

FIG. 6 is a diagram for explaining an arithmetic method of processing the first information by a method different for each of the processing devices 20 according to the embodiment.

FIG. 6 illustrates, in the upper stage thereof, an example of a bit string corresponding to the first information I1 included in a confirmation request and a bit string corresponding to the second information I2 set in common for the processing devices 20.

Here, each of the processing devices 20 may process the first information I1 by an individually different method, and use the processed first information for an arithmetic operation. The above-described processing includes, for example, an increment.

For example, in the case of an example illustrated in FIG. 6, the processing device 20a may increment the first digit of the bit string corresponding to the first information I1 by 1, and perform an arithmetic operation using the first information I1a processed by the increment and the second information I2 to obtain an arithmetic result CRa.

Meanwhile, the processing device 20b may increment the second digit of the bit string corresponding to the first information I1 by 1, and perform an arithmetic operation using the first information I1b processed by the increment and the second information I2 to obtain an arithmetic result CRb.

Note that although the above has exemplified the increment as the processing performed on the first information I1, the method of processing performed on the first information I1 according to the embodiment is not limited thereto. The processing performed on the first information I1 may be a decrement, for example, or another method may be applied.

In the above-described processing, each of the processing devices 20 can obtain a mutually different arithmetic result CR using the same first information I1 and the same second information I2.

Moreover, for example, the arithmetic method specific to each of the processing devices according to the embodiment may include extracting a bit string different for each of the processing devices 20 from a bit string corresponding to the second information set in common for the processing devices 20.

In this case, each of the processing devices may perform an arithmetic operation using the first information and the second information set in common for the processing devices 20, and transmit a confirmation response including a result of the arithmetic operation to the control device 10.

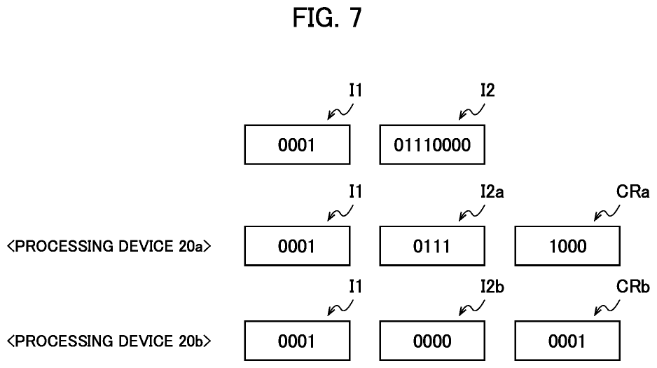

FIG. 7 is a diagram for explaining an arithmetic method of extracting a bit string different for each of the processing devices 20 from a bit string corresponding to the second information according to the embodiment.

FIG. 7 illustrates, in the upper stage thereof, an example of a bit string corresponding to the first information I1 included in a confirmation request and a bit string corresponding to the second information I2 set in common for the processing devices 20.

Here, each of the processing devices 20 may extract an individually different bit string from the bit string corresponding to the second information I2, and use the extracted bit string for an arithmetic operation.

For example, in the case of an example illustrated in FIG. 7, the processing device 20a may extract a bit string of the first four digits from the bit string corresponding to the second information I2, and perform an arithmetic operation using the extracted bit string I1a and the first information I1 to obtain an arithmetic result CRa.

Meanwhile, the processing device 20b may extract a bit string of the last four digits from the bit string corresponding to the second information I2, and perform an arithmetic operation using the extracted bit string I2b and the first information I1 to obtain an arithmetic result CRb.

Note that although the above has exemplified the case where each of the processing devices 20 extracts a bit string not overlapping mutually from the bit string corresponding to the second information I2, a part of the bit strings extracted by the processing devices 20 may be overlapped.

In the above-described processing, each of the processing devices 20 can obtain a mutually different arithmetic result CR using the same first information I1 and the same second information I2.

Moreover, for example, the arithmetic method specific to each of the processing devices according to the embodiment may include processing the second information set in common for the processing devices 20 by a method different for each of the processing devices 20.

In this case, each of the processing devices 20 may perform an arithmetic operation using the first information included in a confirmation request and the individually processed second information, and transmit a confirmation response including a result of the arithmetic operation to the control device 10.

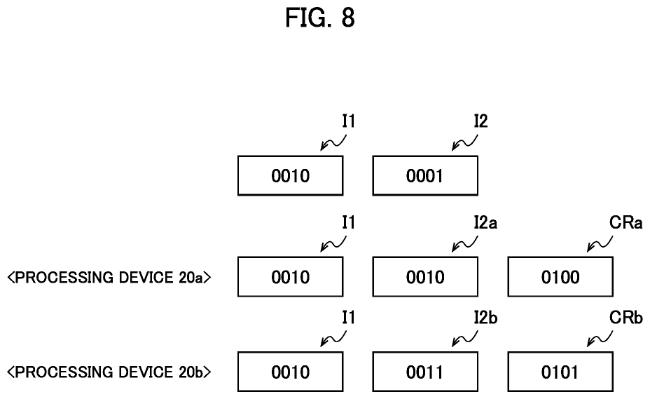

FIG. 8 is a diagram for explaining an arithmetic method of processing the second information by a method different for each of the processing devices 20 according to the embodiment.

FIG. 8 illustrates, in the upper stage thereof, an example of a bit string corresponding to the first information I1 included in a confirmation request and a bit string corresponding to the second information I2 set in common for the processing devices 20.

Here, each of the processing devices 20 may process the second information I2 by an individually different method, and use the processed second information for an arithmetic operation. The above-described processing includes, for example, an increment.

For example, in the case of an example illustrated in FIG. 8, the processing device 20a may increment the first digit of the bit string corresponding to the second information I2 by 1, and perform an arithmetic operation using the second information I1a processed by the increment and the first information I1 to obtain an arithmetic result CRa.

Meanwhile, the processing device 20b may increment the second digit of the bit string corresponding to the second information I2 by 1, and perform an arithmetic operation using the second information I2b processed by the increment and the first information I1 to obtain an arithmetic result CRb.

Note that although the above has exemplified the increment as the processing performed on the second information I2, the method of processing performed on the second information I2 according to the embodiment is not limited thereto. The processing performed on the second information I2 may be a decrement, for example, or another method may be applied.

In the above-described processing, each of the processing devices 20 can obtain a mutually different arithmetic result CR using the same first information I1 and the same second information I2.

Moreover, for example, the arithmetic method specific to each of the processing devices according to the embodiment may include extracting a bit string different for each of the processing devices 20 from a result of an arithmetic operation using the first information included in a confirmation request and the second information set in common for the processing devices 20.

In this case, each of the processing devices 20 may transmit a confirmation response including a bit string individually extracted from the above-described arithmetic result to the control device 10.

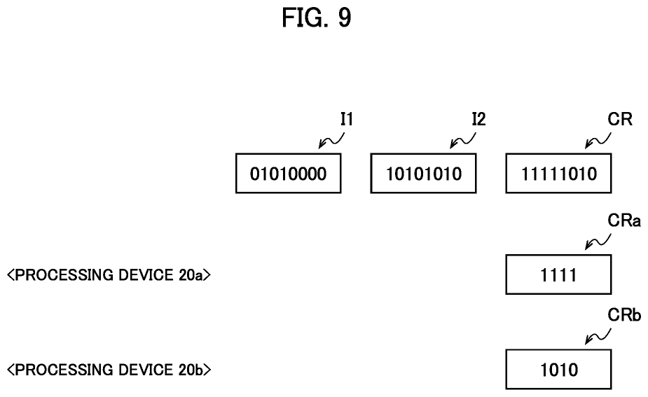

FIG. 9 is a diagram for explaining an arithmetic method of extracting a bit string different for each of the processing devices 20 from an arithmetic result according to the embodiment.

FIG. 9 illustrates, in the upper stage thereof, an example of a bit string corresponding to the first information I1 included in a confirmation request, a bit string corresponding to the second information I2 set in common for the processing devices 20, and a bit string corresponding to a result CR of an arithmetic operation using the first information I1 and the second information.

Here, each of the processing devices 20 performs an arithmetic operation using the first information I1 and the second information, obtains an arithmetic result CR, and extracts an individually different bit string from the arithmetic result CR.

For example, in the case of an example illustrated in FIG. 9, the processing device 20a may extract a bit string of the first four digits from the bit corresponding to the arithmetic result CR, and transmit a confirmation response including the extracted bit string CRa to the control device 10.

Meanwhile, the processing device 20b may extract a bit string of the last four digits from the bit corresponding to the arithmetic result CR, and transmit a confirmation response including the extracted bit string CRb to the control device 10.

Note that although the above has exemplified the case where each of the processing devices 20 extracts a bit string not overlapping mutually from the bit string corresponding to the arithmetic result CR, a part of the bit strings extracted by the processing devices 20 may be overlapped.

In the above-described processing, each of the processing devices 20 can generate a confirmation response including a mutually different bit string using the same first information I1 and the same second information I2.

Moreover, for example, the arithmetic method specific to each of the processing devices according to the embodiment may include processing a result of an arithmetic operation using the first information included in a confirmation request and the second information set in common for the processing devices 20 by a method different for each of the processing device 20.

In this case, each of the processing devices 20 may transmit a confirmation response including the processed arithmetic result to the control device 10.

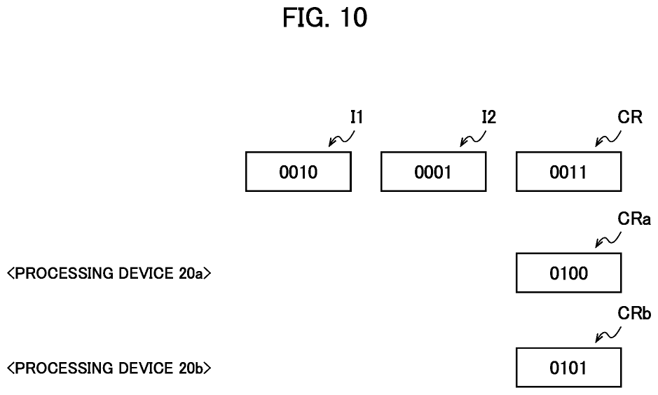

FIG. 10 is a diagram for explaining an arithmetic method of processing an arithmetic result by a method different for each of the processing devices 20 according to the embodiment.

FIG. 10 illustrates, in the upper stage thereof, an example of a bit string corresponding to the first information I1 included in a confirmation request, a bit string corresponding to the second information I2 set in common for the processing devices 20, and a bit string corresponding to a result CR of an arithmetic operation using the first information I1 and the second information.

Here, each of the processing devices 20 performs an arithmetic operation using the first information I1 and the second information, obtains an arithmetic result CR, and processes the arithmetic result CR by an individually different method. The above-described processing includes, for example, an increment.

For example, in the case of an example illustrated in FIG. 10, the processing device 20a may increment the first digit of the bit string corresponding to the arithmetic result CR by 1, and obtain an arithmetic result CRa processed by the increment.

Meanwhile, the processing device 20b may increment the second digit of the bit string corresponding to the arithmetic result CR by 1, and obtain an arithmetic result CRb processed by the increment.

Note that although the above has exemplified the increment as the processing performed on the arithmetic result CR, the method of processing performed on the arithmetic result CR according to the embodiment is not limited thereto. The processing performed on the arithmetic result CR may be a decrement, for example, or another method may be applied.

In the above-described processing, each of the processing devices 20 can generate a confirmation response including a mutually different bit string using the same first information I1 and the same second information I2.

The above has described the arithmetic method specific to each of the processing devices 20 according to the embodiment using the concrete examples.

Note that for the convenience of explanation, FIG. 5 to FIG. 10 illustrate the first information I1, the second information I2, and the arithmetic result CR with a data length of 4 bits of 8 bits. However, the data lengths of the first information I1, the second information I2, and the arithmetic result CR of the embodiment are not limited to the above-described examples, and can be designed arbitrarily.

Moreover, for the convenience of explanation, FIG. 5 to FIG. 10 exemplify the case where each of the processing devices 20 simply adds the first information I1 and the second information I2 to obtain the arithmetic result CR. However, the arithmetic operation using the first information I1 and the second information I2 according to the embodiment is not limited thereto. Each of the processing devices 20 of the embodiment may perform an arbitrary arithmetic operation using the advanced encryption standard (AES) or the like.

### 2. Supplement

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

A sequence of processing by the devices described in the specification may be achieved using any one of software, hardware, and the combination of software and hardware. A program forming the software is preliminarily stored in a non-transient storage medium provided inside or outside the devices, for example. Then, each program is read in a random access memory (RAM) when executed by a computer, and executed by a processor such as a central processing unit (CPU). The above-described storage medium includes, for example, a magnetic disk, an optical disk, a magnetooptical disk, a flash memory, or the like. Moreover, the above-described computer program may be distributed through a network, for example, without using any storage medium.

What is claimed is:

1. A system, comprising:
a first device; and
a plurality of second devices, wherein
the first device transmits a generated confirmation request including first information to the second devices,
each of the second devices performs an arithmetic operation based on the received confirmation request, second information set in common for the second devices, and an arithmetic method specific to each of the second devices, and transmits a confirmation response including a result of the arithmetic operation to the first device, and
the first device authenticates each of the second devices on the basis of the confirmation response transmitted by each of the second devices.

2. The system according to claim 1, wherein
the arithmetic method specific to each of the second devices includes extracting a bit string different for each of the second devices from a bit string corresponding to the first information, and
each of the second devices performs an arithmetic operation using the bit string individually extracted from the bit string corresponding to the first information and the second information, and transmits the confirmation response including a result of the arithmetic operation to the first device.

3. The system according to claim 1, wherein
the arithmetic method specific to each of the second devices includes processing the first information by a method different for each of the second devices, and
each of the second devices performs an arithmetic operation using the individually processed first information and the second information, and transmits the confirmation response including a result of the arithmetic operation to the first device.

4. The system according to claim 1, wherein
the arithmetic method specific to each of the second devices includes extracting a bit string different for each of the second devices from a bit string corresponding to the second information, and
each of the second devices performs an arithmetic operation using the first information and the bit string individually extracted from the bit string corresponding to the second information, and transmits the confirmation response including a result of the arithmetic operation to the first device.

5. The system according to claim 1, wherein
the arithmetic method specific to each of the second devices includes processing the second information by a method different for each of the second devices, and
each of the second devices performs an arithmetic operation using the first information and the individually processed second information, and transmits the confirmation response including a result of the arithmetic operation to the first device.

6. The system according to claim 1, wherein
the arithmetic method specific to each of the second devices includes extracting a bit string different for each of the second devices from a result of an arithmetic operation using the first information and the second information, and
each of the second devices transmits the confirmation response including the bit string individually extracted from the result of the arithmetic operation to the first device.

7. The system according to claim 1, wherein
the arithmetic method specific to each of the second devices includes processing a result of an arithmetic operation using the first information and the second information by a method different for each of the second devices, and
each of the second devices transmits the confirmation response including the individually processed result of the arithmetic operation to the first device.

8. A control device, comprising:
a control unit configured to transmit a generated confirmation request including first information to other devices, and authenticate the other devices on the basis of a confirmation response transmitted by the other devices in response to the confirmation request, wherein
the control unit transmits the confirmation request to the other devices, and receives, from each of the other devices, a confirmation response including a result of an arithmetic operation based on the confirmation request, second information set in common for the other devices, and an arithmetic method specific to each of the other devices.
